(19) United States
(12) Patent Application Publication
(10) Pub. No.: US 2014/0078731 A1
(43) Pub. Date: Mar. 20, 2014

(54) LED SOCKET ADAPTER ASSEMBLY

(71) Applicant: Gregory S. Harruff, Rio, WI (US)

(72) Inventor: Gregory S. Harruff, Rio, WI (US)

(21) Appl. No.: 13/619,063

(22) Filed: Sep. 14, 2012

(51) Int. Cl. F21V 7/00

(52) U.S. Cl. 362/235

(57) ABSTRACT

A light-emitting assembly for use in a fluorescent light system includes two socket apertures spaced a distance from one another. The assembly includes a reflector extending a length that is less than the distance, the reflector including a reflective surface. Light emitters are positioned on the reflector and spaced apart from one another, a first socket adapter is coupled to a first end of the reflector and arranged to be received within a first of the socket apertures, and a second socket adapter is coupled to a second end of the reflector and is arranged to be received within a second of the socket apertures opposite the first socket aperture.

### BACKGROUND

The present invention relates to light-emitting assemblies. More specifically, the present invention is related to an LED socket adapter assembly for use in a fluorescent light replacement fixture.

Large buildings such as office buildings and signs typically include fluorescent lighting. The lighting is typically arranged in fixtures that are arranged to receive one or more elongated or shaped fluorescent light tubes. In many cases, the fluorescent light tubes are received in fluorescent sockets that are supported in standard D-shaped apertures. Newer LED technology brings the advantages of lower energy consumption, longer life, improved low temperature performance, and other advantages. It is desirable to provide a retrofit illumination system to bring these advantages to signs and lighting fixtures.

### SUMMARY

In one embodiment, the invention provides a light-emitting assembly for use in a fluorescent light system including two socket apertures spaced a distance from one another. The assembly includes a reflector extending a length that is less than the distance, the reflector including a reflective surface. Light emitters are positioned on the reflector and spaced apart from one another, a first socket adapter is coupled to a first end of the reflector and arranged to be received within a first of the socket apertures, and a second socket adapter is coupled to a second end of the reflector and is arranged to be received within a second of socket apertures opposite the first socket aperture.

In another embodiment, the invention provides a socket adapter for connecting a light-emitting assembly to a housing. The socket adapter includes a first body portion including a first reflector engagement surface, a first engagement member, and a first alignment member. A second body portion is selectively attachable to the first body portion and includes a second reflector engagement surface, a second engagement member, and a second alignment member arranged such that the second engagement member engages the first engagement member and the second alignment member engages the first alignment member to attach the second body portion to the first body portion. The second reflector engagement surface is spaced a non-zero parallel distance from the first reflector attachment surface to clamp a reflector therebetween. An engagement portion is coupled to the first body portion and is arranged to engage one of a fluorescent light socket and a socket aperture formed in the housing.

Other aspects of the invention will become apparent by consideration of the detailed description and accompanying drawings.

### BRIEF DESCRIPTION OF THE DRAWINGS

FIG. 1 is a perspective view of a sign or light box including several light-emitting assemblies;

FIG. 2 is an exploded perspective view of a socket adapter of one of the light-emitting assemblies of FIG. 1;

FIG. 3 is a perspective view of the socket adapter of FIG. 2;

FIG. 4 is a perspective view of a first body portion of the socket adapter of FIG. 3;

FIG. 5 is another perspective view of the first body portion of the socket adapter of FIG. 3;

FIG. 6 is a perspective view of a second body portion of the socket adapter of FIG. 3;

FIG. 7 is another perspective view of the second body portion of the socket adapter of FIG. 3;

FIG. 8 is an exploded perspective view of another socket adapter for use with one of the light-emitting assemblies of FIG. 1;

FIG. 9 is a perspective view of a first body portion of the socket adapter of FIG. 8;

FIG. 10 is a top view of a spacer member of the socket adapter of FIG. 8;

FIG. 11 is a perspective view of the spacer member of the socket adapter of FIG. 8; and

FIG. 12 is a perspective view of a fluorescent light socket positioned in a D-shaped aperture of the housing of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

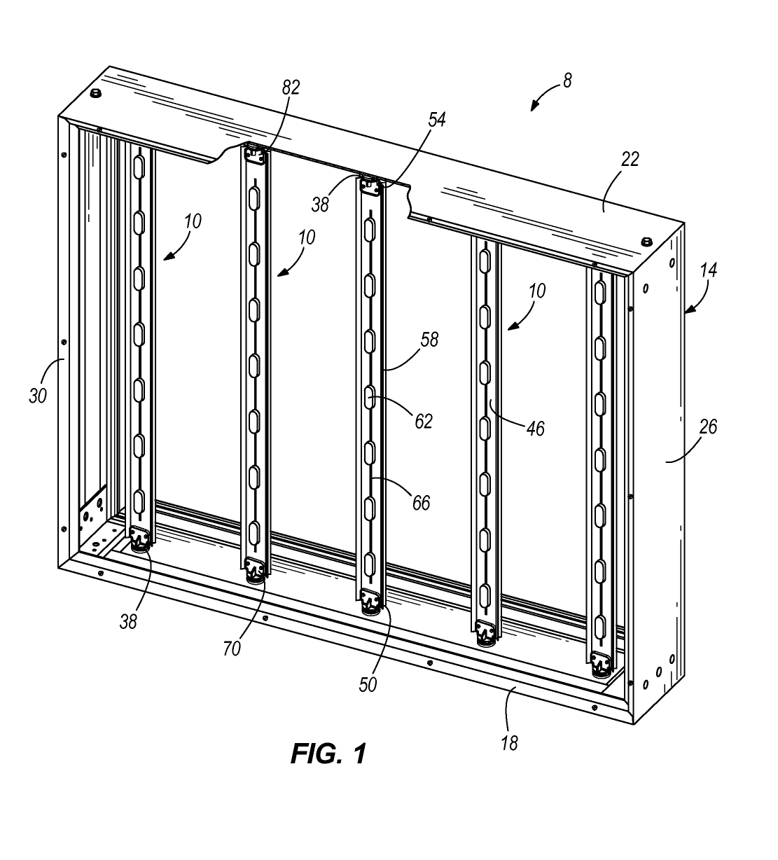

Referring to FIG. 1, the present invention provides a sign or light box 8 that includes one or more light-emitting assemblies 10 that replace existing fluorescent lights. The light box 8 or sign includes a frame 14 having a first wall 18, a second wall 22, a third wall 26, and a fourth wall 30. The third wall 26 and the fourth wall 30 extend between the first wall 18 and the second wall 22 such that the second wall 22 is spaced apart at a non-zero parallel distance from the first wall 18. The frame 14 is typically built into a ceiling space (not shown) or is part of a sign or other light-emitting apparatus and is arranged to receive a plurality of tubular or shaped fluorescent lights (not shown).

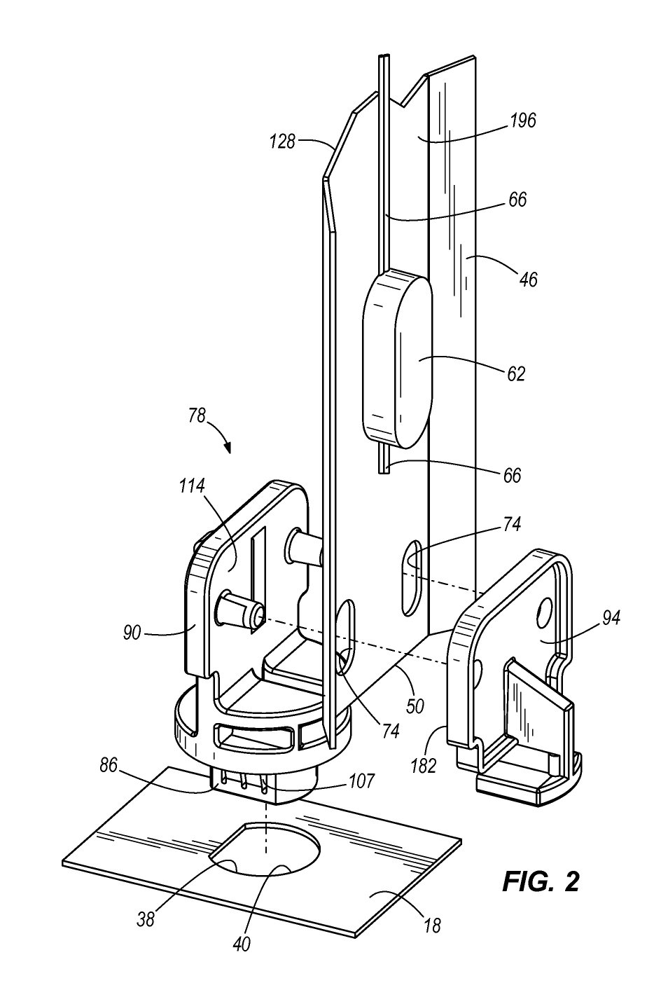

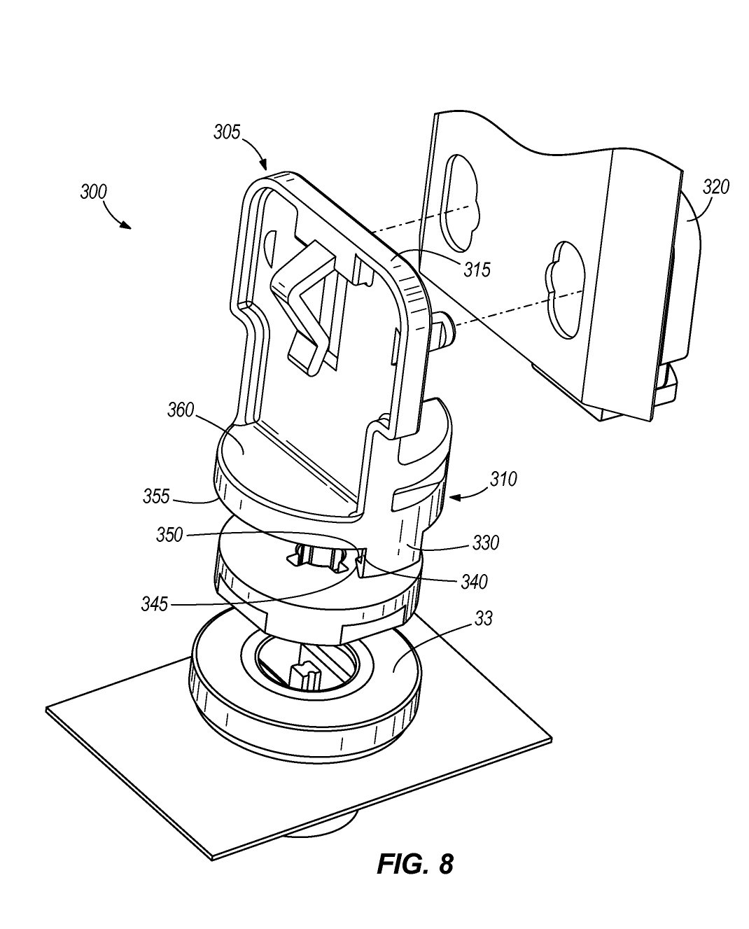

A number of apertures 38 are formed or positioned in the first wall 18, with an equal number formed or positioned in the second wall 22. The apertures 38 are arranged in pairs to receive and support one of a plurality of fluorescent sockets 33 (shown in FIG. 8) that in turn support fluorescent light tubes (not shown). Each of the apertures 38 is preferably configured with a D-shaped opening 40 (FIG. 2) or other standard aperture shape that is commonly used with fluorescent sockets 33. In the illustrated construction, the apertures 38 are spaced at a predefined distance from one another to receive a desired length fluorescent light tube.

With continued reference to FIG. 1, each light-emitting assembly 10 includes a reflector 46 that extends between the first wall 18 and the second wall 22. The reflector 46 has a length that is less than the predefined distance to assure that the reflector 46 fits between the two apertures 38. Each reflector 46 includes a first end 50, a second end 54, and a center portion 58. A number of LEDs 62 are positioned in the center portion 58 of each of the reflectors 46 and connect to at least one electrical conductor 66. Each of the first end 50 and the second end 54 include a pair of apertures 74 as illustrated in FIG. 2. Each reflector receives a first socket adapter 78 which is selectively clamped to the reflector 46 adjacent the pair of apertures 74 on the first end 50 and a second socket adapter 82 which is selectively clamped to the reflector 46 adjacent the pair of apertures 74 on the second end 54 (FIG. 1). In a preferred construction, the first socket adapter 78 and the second socket adapter 82 are substantially the same. However, some constructions may use different adapters at the different ends of the reflector 46. It should be noted that the constructions illustrated herein show LEDs 62 positioned on one side of the reflector 46. However, other constructions may include LEDs 62 on both sides of the reflector 46 or on more than two sides of the reflector 46 as with double-faced signs.

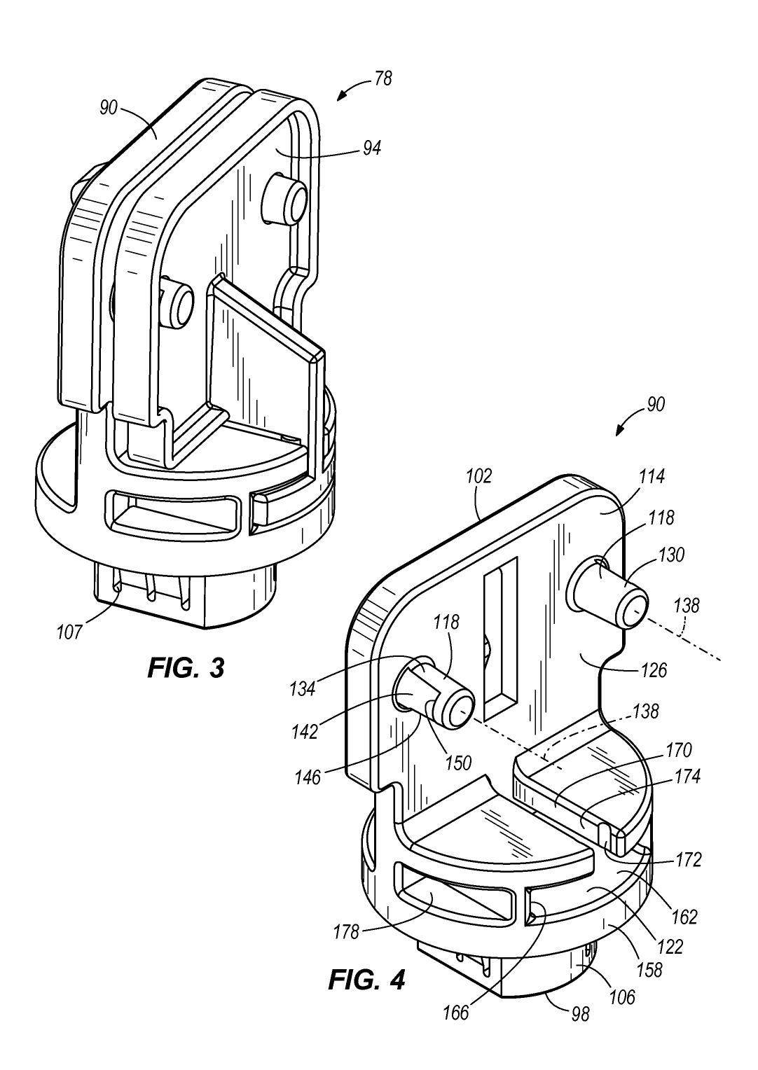

Referring to FIG. 2, the first socket adapter 78 is received in a first of the apertures 38 of the first wall 18. As will be discussed with regard to FIGS. 3-8, the socket adapter 78 includes a portion 86 sized and shaped to be received by the aperture 38.

As illustrated in FIG. 3, the first socket adapter 78 includes a first body portion 90 selectively attached to a second body portion 94 to clamp the first socket adapter 78 to the first of the plurality of reflectors 46 (FIG. 2).

As shown in FIG. 4, the first body portion 90 includes a first end 98 and a second end 102. The first end 98 includes a portion 106 arranged to be received within the standard D-shaped aperture 38 (FIG. 2). In the illustrated construction, the portion 106 includes two planar surfaces arranged normal to one another with a cylindrical wall completing the portion 106. The arrangement of the portion 106 allows the first body portion 90 to be inserted into the D-shaped aperture 38 in one of two arrangements that are approximately normal to one another. In addition, the reflector 46 can be flipped and attached to the first body portion 90 in one of two orientations that are opposite one another. Thus, the combination of the shape of the portion 106 and the ability to flip the reflector 46 allows a user to direct the emitted light in any of four directions that are about ninety degrees from one another. As one of ordinary skill in the art will realize, other shaped apertures may be employed and the first end 98 could be arranged to accommodate many if not all of these various arrangements to allow the first end 98 to be received by virtually any shaped aperture.

In preferred constructions, the aperture 38 is formed in a relatively thin component such as a sheet metal wall. The first end 98 includes a plurality of wedge members 107 arranged to engage the thin component to hold the first body portion 90 in engagement with the thin component.

The second end 102 of the first body portion 90 includes a first reflector engagement surface 114, a first alignment member 118, and a first engagement member 122. The first reflector engagement surface 114 includes a substantially planar surface 126 arranged to contact a substantially planar surface 128 (FIG. 2) of the reflector 46.

With continued reference to FIG. 4, the first alignment member 118 includes a first boss 130 and a second boss 134 that each extend from the first reflector engagement surface 114. The first boss 130 and the second boss 134 are substantially frustoconical protrusions that each extend along an axis 138 that is substantially perpendicular to the first reflector engagement surface 114. The first boss 130 is spaced a predetermined distance from the second boss 134. Each of the first boss 130 and the second boss 134 includes a relieved portion 142 disposed on an outermost surface 146 of each of the bosses 130, 134. The relieved portion 142 is positioned axially below the end of each boss 130, 134 such that the relieved portion 142 defines a lip 150 on the outer surface 146 of each of the bosses 130, 134.

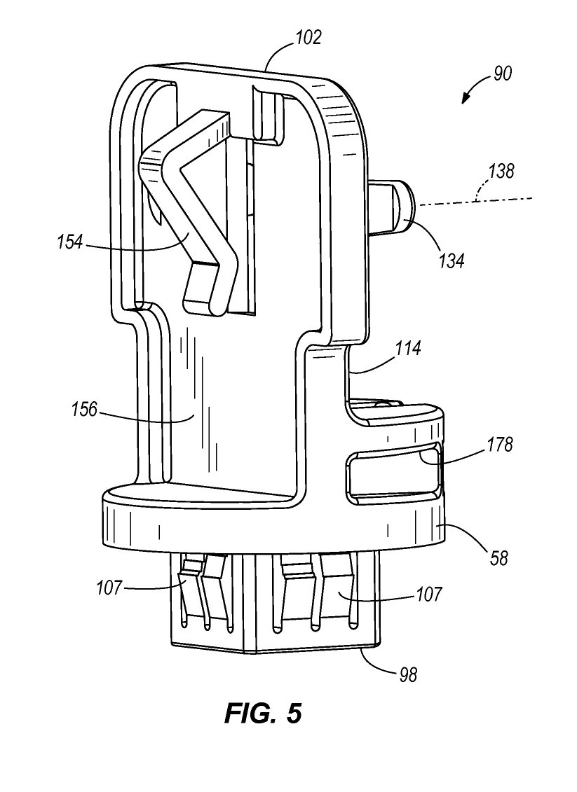

As shown in FIG. 5, a clip portion 154 is disposed on an outer surface 156 of the first body portion 90 opposite the bosses 130, 134. The clip portion 154 is sized and arranged to receive and hold any excess wire (not shown) at the end of an LED string (not shown).

With continued reference to FIG. 4, the first end 98 includes a substantially cylindrical portion 158 that is perpendicular to the first reflector engagement surface 114 and positioned between the first reflector engagement surface 114 and the first end 98 of the first body portion 90. The first engagement member 122 is at least partially formed as part of the cylindrical portion 158. The first engagement member 122 includes a T-shaped slot 162 that includes an elongated slot 166 disposed within the cylindrical portion 158 and a narrow slot 170 extending from the elongated slot 166 through the cylindrical portion 158 in a direction toward the first reflector engagement surface 114. A cylindrical groove 172 is formed in each of the walls 174 that define the narrow slot 170. Each of the grooves 172 extends in a direction that is parallel to the first reflector engagement surface 114 and perpendicular to the long axis of the elongated slot 166. Additional slots 178 are disposed within the cylindrical portion 158 on either side of the elongated slot 166 of the T-shaped slot 162.

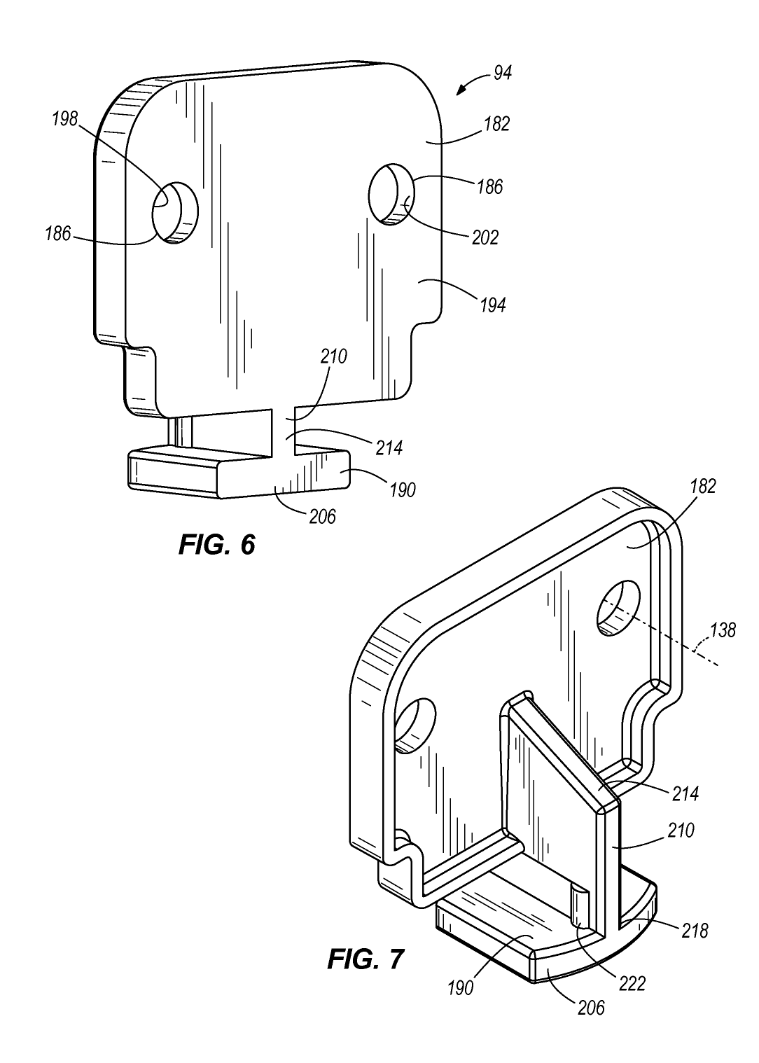

Referring to FIGS. 6 and 7, the second body portion 94 includes a second reflector engagement surface 182, a second alignment member 186, and a second engagement member 190. The second reflector engagement surface 182 includes a substantially planar surface 194 arranged to contact a substantially planar surface 196 (FIG. 2) of the reflector 46. Referring to FIG. 2, the second reflector engagement surface 182 is spaced a non-zero parallel distance from the first reflector engagement surface 114 when the first body portion 90 and the second body portion 94 are attached to one another to clamp one of the plurality of reflectors 46 therebetween.

As shown in FIG. 6, the second alignment member 186 includes a first aperture 198 sized to receive the first boss 130 and a second aperture 202 sized to receive the second boss 134. The first aperture 198 and the second aperture 202 extend through the second reflector engagement surface 182 in a direction that is substantially perpendicular to the second reflector engagement surface 182.

As illustrated in FIG. 7, the second engagement member 190 includes a T-shaped portion 206 that extends from the second reflector engagement surface 182. The T-shaped portion 206 includes an elongated portion 210 that is connected to the second reflector engagement surface 182 via a narrow portion 214. An end 218 of the narrow portion 214 extends away from the second reflector engagement surface 182 and includes a pair of partial cylindrical protrusions 222 that extend along parallel axes that are normal to the long axis of the elongated portion 206 of the T-shaped portion 206.

To produce the assembly 10 for use in replacing the fluorescent light tube, the reflector 46 is formed to the desired length and surface area. The reflector 46 may include a heat sink and other components that may affect the ultimate surface area of the reflector 46. However, the length is largely determined by the length of fluorescent light tube being replaced.

LEDs 62 are placed on the reflector 46 at a spacing and in a quantity that provides the desired lighting level. In the illustrated construction, tape or adhesives (not shown) are used to attach the LEDs 62 to the reflector 46 with other attachment means being possible. Conductors (not shown) extend to one or both ends 50, 54 of the reflector 46 and between the LEDs 62 to facilitate an electrical connection.

The first body portion 90 of the socket adapters 78, 82 are first positioned within the D-shaped apertures 38 of the frame 14. More specifically, the D-shaped portions 106 of the first body portions 90 of the adapters 78, 82 are inserted into the D-shaped apertures 38. As the D-shaped portions 106 are inserted, the wedge member 107 passes through the aperture 38 to sandwich the thin walled portion between the wedge members 107 and the cylindrical portion 158. The reflector 46 is then positioned adjacent the first body portions 90 and the bosses 130, 134 are pushed through the apertures 74 in the reflector 46 until the first reflector engagement surface 114 engages the reflector 46. The second body portion 94 is positioned adjacent the first body portion 90 and the reflector 46 and is pushed in an engagement direction into engagement with the first body portion 90. The apertures 198, 202 of the second alignment member 186 receive the bosses 130, 134 of the first alignment member 118. As the bosses 130, 134 pass through the apertures 198, 202, the relieved portions 142 enter and pass through the apertures 198, 202 such that the lip 150 defined by the relieved portions 142 engage the second body portion 94 and inhibit movement in the opposite direction. The T-shaped portion 206 of the second engagement member 190 engages the T-shaped slot 162 of the first engagement member 122 as the second body portion 94 moves toward the first body portion 90. The engagement members 122, 190 are arranged to inhibit unwanted movement of the second body portion 94 with respect to the first body portion 90 in a direction normal to the engagement direction. The cylindrical protrusions 222 engage the cylindrical grooves 172 to further inhibit unwanted movement of the second body portion 94 in the engagement direction. Once in the final position, the second reflector engagement surface 182 is spaced a distance from the first reflector engagement surface 114 such that the first body portion 90 and the second body portion 94 clamp the reflector 46.

If the assembly 10 is oriented such that the bosses 130, 134 are vertically aligned, the relieved portions 142 provide a flat surface 146 that supports the reflector 46 with more stability than if the bosses 130, 134 did not include the relieved portions 142.

With reference to FIG. 1, the second socket adapter 82 is clamped to the second end 54 of the first of the plurality of reflectors 46. The second socket adapter 82 is arranged to engage a second of the plurality of apertures 38 of the second wall 22. The insertion of the first socket adapter 78 into the first aperture 38 and the insertion of the second socket adapter 82 into the second aperture 38 supports the assembly 10 in the space previously occupied by the fluorescent light. The conductors 66 are connected to a power supply (not shown) that connects to the power supply or directly to the supplied AC power to provide electrical power to the LEDs 62. The electrical connection is made separate from the mechanical support provided by the socket adapters 82.

FIGS. 8-13 illustrate another arrangement of a socket adapter 300 for use in replacing a fluorescent light tube with a series of LEDs. The socket adapter 300 includes a first body portion 305 having a first end 310 and a second end 315 and a second body portion 320. In this construction, the second end 315 of the first body portion 305 and the second body portion 320 are substantially the same as those described with regard to FIGS. 2-7. The first end 310 of the first body portion 305 is different to allow for the reuse of a fluorescent light socket 33.

As illustrated in FIG. 8, the thin-walled member includes a D-shaped aperture 38 (shown in FIG. 2) that is sized to receive the standard socket 33 for a fluorescent light. In the construction of FIGS. 1-8, that socket 33 is removed and the socket adapter 78 is placed directly in the D-shaped aperture 38. In the construction of FIGS. 8-13, the fluorescent light socket 33 is left in place and the socket adapter 300 is formed to be held in place by the socket 33.

The first end 310 of the first body portion 305 includes two hook members 330 and a central post 335 that extend away from the second end 315 of the body portion 305. Each hook member 330 includes an arm 340 that extends away from the second end 315 of the body portion 305 and a hook end 345 that defines a hook surface 350 that is substantially parallel to and opposite a bottom surface 355 of a cylindrical portion 360 of the first body portion 305.

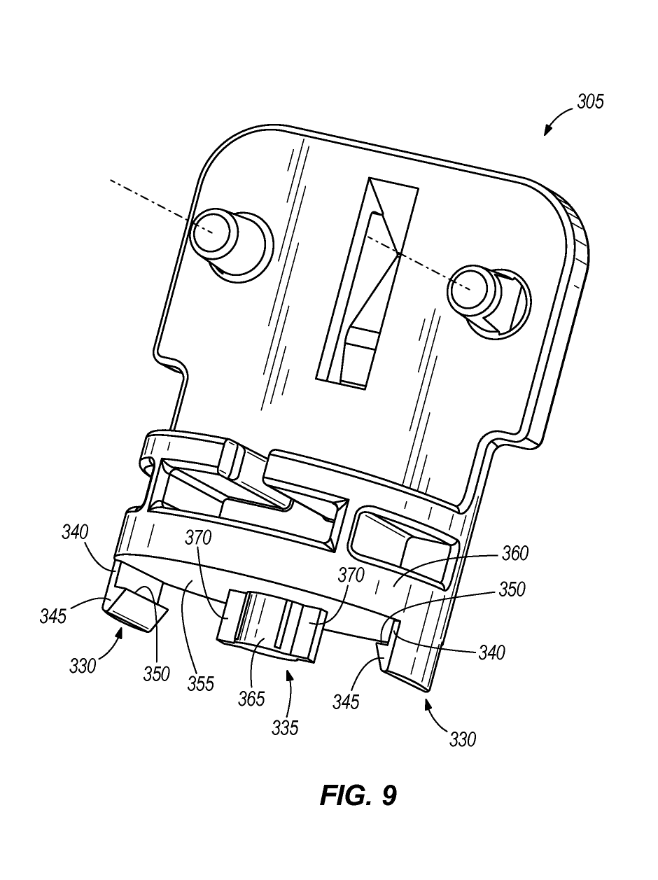

The central post 335, illustrated in FIG. 9, includes a cylindrical portion 365 and at least one radial arm 370 extending outward from the cylindrical portion 365. Other constructions include fewer or more radial arms 370 as may be required. In addition, other constructions may omit the arms 370 or may include a non-cylindrical portion (e.g., rectangular, polygonal, irregular, elliptical, oval, etc.).

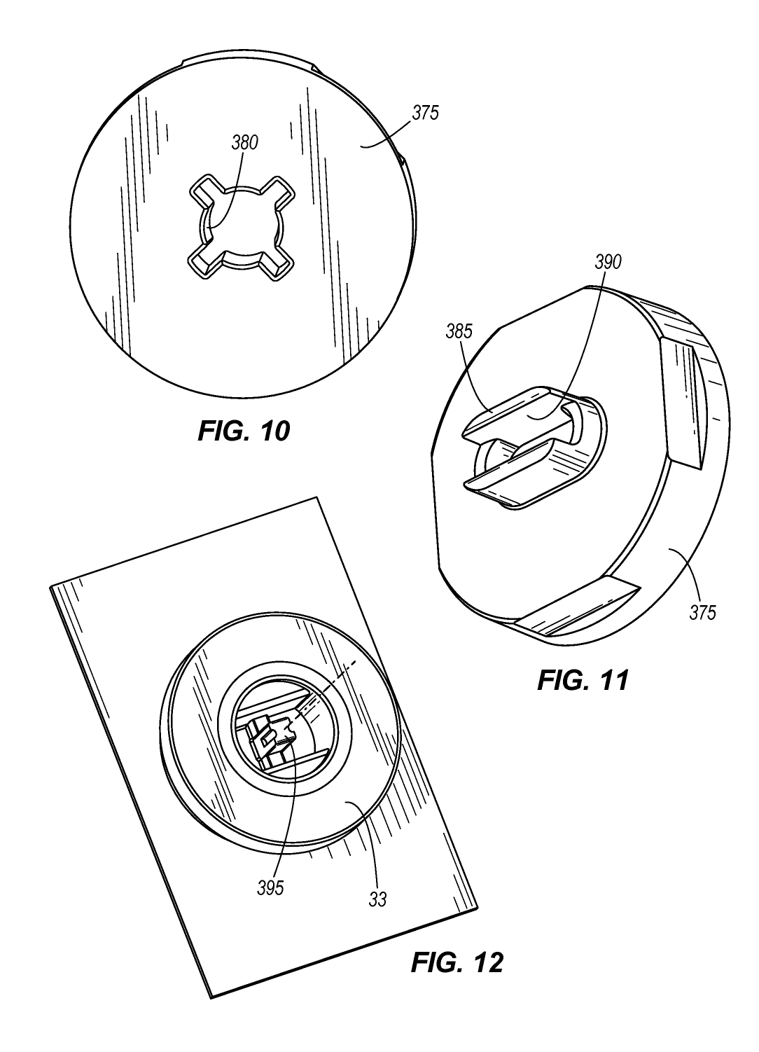

A spacer member 375 is positioned between the socket 33 and the first body portion 305 and is arranged to engage the hook members 330, the central post 335, and the socket 33 to connect the socket adapter 300 to the fluorescent light socket 33. The spacer 375, illustrated in FIGS. 10 and 11 includes an aperture 380 arranged to receive the central post 335 and a protrusion 385 arranged to engage the fluorescent socket 33. In the illustrated construction, the aperture 380 receives the central post 335 to inhibit rotation of the spacer member 375 with respect to the first body portion 305 and to assure that the spacer 375 has the desired alignment with respect to the first body portion 305.

The protrusion 385 can have any arrangement necessary to assure the desired engagement with the socket 33. In the illustrated construction, the protrusion 385 has a substantially oval arrangement with a slot 390 extending along the long axis of the oval. The slot 390 is sized to engage a square or rectangular protrusion 395 within the socket 33. Once engaged, rotation of the spacer member 375 with respect to the socket 33 is inhibited.

The spacer 375 is received within the space between the hook surface 350 and the cylindrical portion 360 and is held in place by the hook members 330. While the illustrated construction includes two hook members 330, other constructions may include three or more hook members 330 or may use other attachment arrangements. In still other constructions, the first body portion 305 and the spacer member 375 are integrally-formed as a single piece. However, it is preferred that the spacer member 375 be separate from the socket adapter 300 as this arrangement allows a single socket adapter design to be received in many different socket designs simply by varying the design of the spacer member 375. The spacer 375 is arranged to be rotated in 90 degree increments before engaging the hook members 330 to allow for engagement with sockets 33 which have a 90 degree rotational orientation with respect to the protrusion 395 (sometimes referred to as horizontal or vertical contacts).

In use, the fluorescent lights of a light fixture or sign are first removed in a conventional manner. If desired, the fluorescent sockets 33 can be removed or can be left in place. Light-emitting assemblies 10 are manufactured to include the reflector 46, the LEDs 62 and electrical connectors 66 connecting the various LEDs 62. Socket adapters 78, 300 are connected to the reflector 46 as described. In arrangements where the socket 33 is removed, the socket adapter 78 of FIGS. 2-7 is employed and the socket adapters 78 are first installed in the frame 14. In arrangements where the socket 33 is retained, the socket adapter 300 of FIGS. 8-12 or another similar adapter can be employed and are connected to the reflector 46 before installation into the frame 14. The socket adapters engage either the D-shaped aperture 38 or the socket 33 to mechanically support the light-emitting assemblies 10 in the space previously occupied by the fluorescent lights. The LEDs 62 can be electrically-connected to the existing fluorescent light power supply or, preferably connected through a separate arrangement that bypasses the existing power supply system of the light box 8 or sign.

Various features and advantages of the invention are set forth in the following claims.

What is claimed is:

1. A light-emitting assembly for use in a fluorescent light system including two socket apertures spaced a distance from one another, the assembly comprising:
a reflector extending a length that is less than the distance, the reflector including a reflective surface;
light emitters positioned on the reflector and spaced apart from one another;
a first socket adapter coupled to a first end of the reflector and arranged to be received within a first of the socket apertures; and
a second socket adapter coupled to a second end of the reflector and arranged to be received within a second of the socket apertures opposite the first socket aperture.

2. The light-emitting assembly of claim 1, wherein the first socket adapter includes a D-shaped portion arranged to be received in the socket aperture.

3. The light-emitting assembly of claim 1, wherein the first socket adapter includes a first body portion and a second body portion selectively attached to the first body portion to clamp the socket adapter to the reflector.

4. The light-emitting assembly of claim 3, wherein the first body portion includes a first reflector engagement surface, a first engagement member, and a first alignment member.

5. The light-emitting assembly of claim 4, wherein the second body portion includes a second reflector engagement surface, a second engagement member, and a second alignment member arranged such that the second engagement member engages the first engagement member and the second alignment member engages the first alignment member to attach the second body portion to the first body portion, the second reflector engagement surface being spaced a non-zero parallel distance from the first reflector attachment surface to clamp the reflector therebetween.

6. The light-emitting assembly of claim 5, wherein one of the first engagement member and the second engagement member includes a T-shaped slot and the other of the first engagement member and the second engagement member includes a T-shaped portion that is received by the T-shaped slot.

7. The light-emitting assembly of claim 5, wherein one of the first engagement member and the second engagement member includes a protrusion and the other of the first engagement member and the second engagement member includes a space sized to receive the protrusion to inhibit disengagement of the first engagement member and the second engagement member.

8. The light-emitting assembly of claim 5, wherein one of the first alignment member and the second alignment member includes a first boss and a second boss spaced apart from the first boss, and the other of the first alignment member and the second alignment member includes a first aperture sized to receive the first boss and a second aperture sized to receive the second boss.

9. The light-emitting assembly of claim 8, wherein the first boss and the second boss are each frustoconical and include a relieved portion.

10. The light-emitting assembly of claim 8, wherein the light emitters include LEDs.

11. A socket adapter for connecting a light-emitting assembly to a housing, the socket adapter comprising:
a first body portion including a first reflector engagement surface, a first engagement member, and a first alignment member;
a second body portion selectively attachable to the first body portion and including a second reflector engagement surface, a second engagement member, and a second alignment member arranged such that the second engagement member engages the first engagement member and the second alignment member engages the first alignment member to attach the second body portion to the first body portion, the second reflector engagement surface being spaced a non-zero parallel distance from the first reflector attachment surface to clamp a reflector therebetween;
an engagement portion coupled to the first body portion and arranged to engage one of a fluorescent light socket and a socket aperture formed in the housing.

12. The socket adapter of claim 11, wherein the engagement portion includes a D-shaped portion and the socket aperture is D-shaped such that the engagement portion is received in the D-shaped socket aperture.

13. The socket adapter of claim 11, further comprising at least two wedge members coupled to the engagement portion, the wedge members cooperating with the first body portion to connect the first body portion to the housing.

14. The socket adapter of claim 11, wherein the D-shaped portion and the wedge members are formed as one piece with the first body portion.

15. The socket adapter of claim 11, wherein one of the first engagement member and the second engagement member includes a T-shaped slot and the other of the first engagement member and the second engagement member includes a T-shaped portion that is received by the T-shaped slot.

16. The socket adapter of claim 11, wherein one of the first engagement member and the second engagement member includes a protrusion and the other of the first engagement member and the second engagement member includes a space sized to receive the protrusion to inhibit disengagement of the first engagement member and the second engagement member.

17. The socket adapter of claim 11, wherein one of the first alignment member and the second alignment member includes a first boss and a second boss spaced apart from the first boss, and the other of the first alignment member and the second alignment member includes a first aperture sized to receive the first boss and a second aperture sized to receive the second boss.

18. The socket adapter of claim 15, wherein the first boss and the second boss are each frustoconical and include a relieved portion.

19. The socket adapter of claim 11, further comprising a spacer member selectively engageable with the engagement portion to couple the first body portion to the fluorescent light socket.

20. The socket adapter of claim 19, wherein the engagement portion includes two hook members and a post member that cooperate to fixedly connect the spacer member to the first body portion.

21. The socket adapter of claim 20, wherein the post member inhibits rotation of the spacer member with respect to the first body portion.
